(19) United States
(12) Patent Application Publication
(10) Pub. No.: US 2015/0192151 A1
(43) Pub. Date: Jul. 9, 2015

(54) HYDRAULIC VALVE ARRANGEMENT

(71) Applicant: Danfoss Power Solutions ApS, Nordborg (DK)

(72) Inventors: Carl Christian Dixen, Sydals (DK); Martin Raadkjaer Joergensen, Soenderborg (DK)

(21) Appl. No.: 14/582,241

(22) Filed: Dec. 24, 2014

(30) Foreign Application Priority Data
Jan. 3, 2014 (EP) 14150162

(51) Int. Cl. F15B 13/02; F15B 13/04

(52) U.S. Cl. CPC F15B 13/026; F15B 13/0417; F15B 13/028; F15B 13/024

(57) ABSTRACT

A hydraulic valve arrangement (1) is described comprising a supply port arrangement having a pressure port (P) and a tank port (T), a working port arrangement having at least a working port (A, B), a main valve (2), and a compensation valve (3), said compensation valve (3) being arranged between said pressure port (P) and a pressure channel (4) connected to said main valve (2), said compensation valve (3) forming a variable orifice between said pressure port (P) and said pressure channel (4). The control behavior of the compensation valve should be extended. To this end said compensation valve (3) is adjustable to connect said pressure channel (4) to said tank port (T).

### CROSS REFERENCE TO RELATED APPLICATION

Applicant hereby claims foreign priority benefits under U.S.C. §119 from European Patent Application No. EP14150162 filed on Jan. 3, 2014, the contents of which are incorporated by reference herein.

### TECHNICAL FIELD

The present invention relates to a hydraulic valve arrangement comprising a supply port arrangement having a pressure port and a tank port, a working port arrangement having at least a working port, a main valve, and a compensation valve, said compensation valve being arranged between said pressure port and a pressure channel connected to said main valve, said compensation valve forming a variable orifice between said pressure port and said pressure channel.

### BACKGROUND

Such a hydraulic valve arrangement is known from DE 198 00 720 C2.

In such a hydraulic valve arrangement the compensation valve can be used to establish a predefined pressure in the pressure channel, i.e. at the pressure inlet of the main valve.

However, the compensation valve can compensate only for pressure losses, i.e. it can supply additional hydraulic fluid to the main valve, if necessary. In other words, if a higher pressure at one of the working ports is necessary, the compensation valve is operated to increase the opening degree of the variable orifice so that a higher pressure can arrive at the pressure input of the main valve.

### SUMMARY

The object underlying the invention is to extend the control behavior of the compensation valve.

This object is solved in a hydraulic valve mentioned at the outset in that said compensation valve is adjustable to connect said pressure channel to said tank port.

In this way the compensation valve is not only able to increase the pressure in the pressure channel, but it is also able to lower the pressure in the pressure channel to the main valve. Such a pressure decrease may be necessary if the pressure at the working port increases due to outer conditions, for example due to forces acting on a device connected to the working port. If such a pressure increase at the working port occurs, this pressure increase reaches the pressure channel via the main valve and can be released from said pressure channel via the compensation valve.

The invention can be used in connection with hydraulic control valve as it is disclosed in U.S. Pat. No. 4,981,159. Such a hydraulic control valve comprises pressure sensing means, wherein a main spool is disposed in a housing bore and is movable out of a neutral position into two operative positions, the main spool has a central collar and two end collars separated therefrom by a respective annular spool 5 groove, the collars have throttle profilings at the confronting sides, the housing bore has an annular pump groove which is supplied with pressure medium and to both sides of which there is a respective annular motor groove connectable to a motor conduit and, to both sides beyond same, a respective annular container groove connectable to the container, and wherein the pressure sensing means comprise at least one pressure sensing orifice which is connected to the conduit at the pressure to be sensed in the operative position of the main spool but separated therefrom in the neutral position. The throttle profilings are confined to circumferential sections and the at least one pressure sensing orifice is disposed at the main spool circumference circumferentially offset from the throttle profilings and connected to a pressure sensing connection by way of a connecting passage in the main spool. In this construction, the pressure sensing orifices as well as the throttle profilings are disposed at the surface of the main spool. They therefore have a fixed relationship to each other. Since they are offset circumferentially, they can have a much smaller axial spacing than hitherto. This is because for sealing purposes it is sufficient if the circumferential section between them is covered by part of the housing bore whilst the connection is produced by the respective annular groove in the housing bore. A smaller axial spacing also results in less dead play. In addition, a main spool with pressure sensing orifices is obtained with an extremely short length.

Preferably said compensation valve is adjustable to interrupt a connection between said pressure port and said pressure channel. If it is not necessary to supply further hydraulic fluid to said working port, but just to hold the pressure, the compensation valve can be used to interrupt the connection between said pressure port and said pressure channel.

Furthermore, it is preferred that said compensation valve interrupts said connection between said pressure port and said pressure channel when connecting said pressure channel to said tank port. When the compensation valve establishes a connection between said pressure channel and said tank port, the supply of fresh hydraulic fluid to said pressure channel should be interrupted in order to save energy. This can easily be made by interrupting the connection between the pressure port and the pressure channel which interruption occurs preferably shortly before the connection between the pressure channel and the tank port is established.

In a preferred embodiment said compensation valve is actuated by a pressure in said pressure channel. This pressure has already been used for adjusting the variable orifice in the compensation valve. The same pressure can be used as well to drive the compensation valve in a condition in which the pressure in the pressure channel can be decreased by connecting the pressure channel to the tank port.

Preferably the hydraulic valve arrangement comprises a housing, said housing having a main bore and a compensation bore, said main bore and said compensation bore being connected by said pressure channel, a main spool slidably arranged within said main bore and forming part of said main valve, a compensation spool slidably arranged within said compensation bore and forming part of said compensation valve, said compensation bore comprising a pressure relief outlet connected to said tank port and said compensation spool being moveable into a pressure relief position in which said pressure relief outlet is connected to said pressure channel. In this embodiment, the pressure relief position can vary as long as it is guaranteed that there is a connection of the pressure relief outlet to said pressure channel. In other words, the compensation spool can adjust the size of an opening through which the hydraulic fluid under pressure can escape from the pressure channel towards the tank port.

Preferably, said compensation spool is moveable in a first direction and in a second direction opposite said first direction, wherein said compensation spool in said first direction is loaded by said pressure in said pressure channel and in said second direction is loaded by a resetting force. The resetting force can at least partly be generated by a return spring or other force generating means.

In a preferred embodiment said resetting force is at least partly formed by a pressure in a load sensing port of said valve arrangement. This is in particular useful when the compensation valve is used to increase the pressure in the pressure channel.

Preferably a plurality of load sensing ports is provided and said resetting force is at least partly formed by the highest of the pressures at said plurality of load sensing ports. In this way, the compensation valve is always able to supply the necessary high pressure.

In a preferred embodiment said pressure relief outlet comprises a groove in a circumferential wall of said compensation bore. This groove can then be covered by the compensation spool in a “normal” mode of operation. However, when the compensation spool is moved far enough, the groove is no longer completely covered, so that hydraulic fluid can enter this groove through a gap between the compensation spool and an edge of this groove so that hydraulic fluid can escape to the tank port.

In such an embodiment it is of advantage that said compensation spool comprises a recess in its circumference, said recess in said pressure relief position connecting said groove to said pressure channel. The size of the recess can be used to design the compensation spool in such a way that the connection between the pressure channel and the tank port has a well-defined flow resistance.

### BRIEF DESCRIPTION OF THE DRAWINGS

A preferred example of the invention will now be described in more detail with reference to the drawing, wherein:

FIG. 1 is a schematic diagram of a hydraulic circuit of the hydraulic valve arrangement according to the present invention,

FIG. 2 is a sectional view of the hydraulic valve arrangement, and

FIGS. 3 to 5 show the hydraulic valve arrangement in three different operational situation.

### DETAILED DESCRIPTION

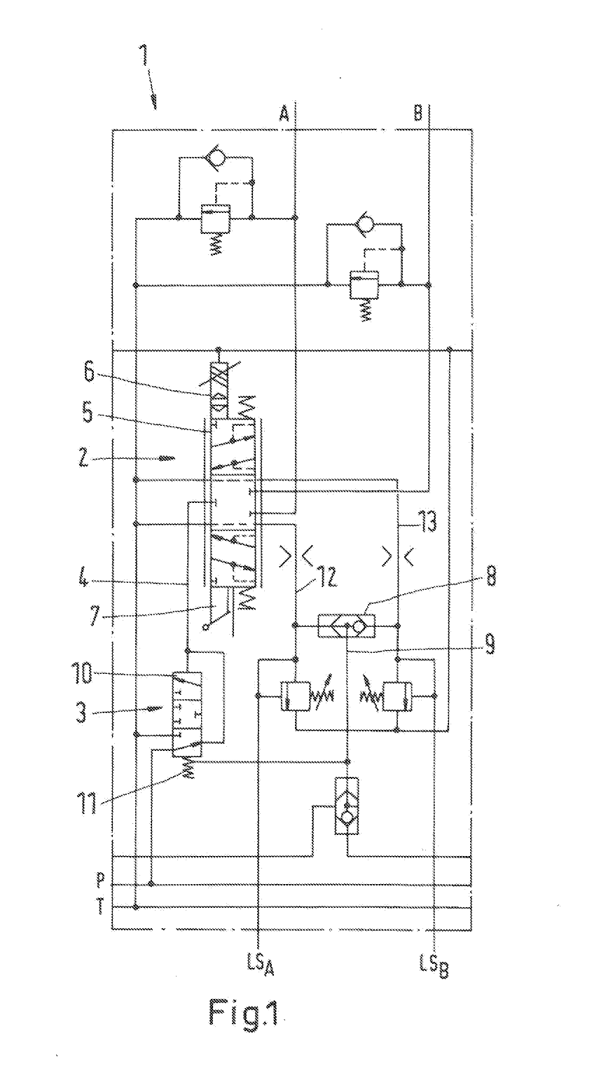

FIG. 1 shows a hydraulic valve arrangement 1 comprising a supply port arrangement having a pressure port P and a tank port T. Furthermore, the hydraulic valve arrangement comprises a working port arrangement having at least a working port. In the present case, there are two working ports A, B,

The hydraulic valve arrangement comprises a main valve 2 and a compensation valve 3. The compensation valve 3 is arranged between said pressure port P and a pressure channel 4 connecting said compensation valve 3 and said main valve 2. The main valve 2 is shown schematically only. The main valve 2 comprises a main spool 5 which can be driven by an electrohydraulic drive 6 and/or by a mechanical drive 7. The main spool 5 establishes in a first position a connection between the pressure channel 4 and one of the working ports A, B and at the same time a connection between the other of the working ports B, A and the tank port T. In a second position of the main spool 5 the connection between the pressure channel 4 and the two working ports A, B is interrupted. In a third position of the main spool 5 the pressure channel 4 is connected to the other of the working ports B, A and the remaining working port A, B is connected to the tank port T.

Furthermore, when the pressure channel 4 is connected to the working port A, it is connected at the same time to a load sensing port LS_{A}. When the pressure channel 4 is connected to the pressure port P, it is connected at the same time to a load sensing port LS_{B}.

The two load sensing ports LS_{A} and LS_{B} are connected via a shuttle valve 8. The shuttle valve 8 comprises a shuttle valve outlet 9 showing the higher of the pressures of the load sensing ports LS_{A} and LS_{B}.

The valve arrangement 1 furthermore shows overpressure relief valves as it is known in the art. These valves are not discussed.

The compensation valve 3 comprises a compensation spool 10 having three positions as well. In a first position the compensation spool 10 connects the pressure port P to the pressure channel 4, as shown.

In a second position of the compensation spool 10 a connection between the pressure port P and the pressure channel 4 is interrupted.

In a third position of the compensation spool 10 the pressure channel 4 is connected to the tank port T.

The compensation spool 10 is loaded by the force of a spring 11 in a first direction. The spring 11 acts to move the compensation spool 10 in the first position shown in FIG. 1. The shuttle valve output 9 is connected to the same side of the compensation spool 10 as the spring 11 acting on the compensation spool 10 in the same direction as the spring 11.

The compensation spool 10 is loaded in the other direction, i.e. in the opposite direction by a pressure in the pressure channel 4, as shown.

If the actuation of a device connected to one of the working ports A, B requires a higher pressure, this higher pressure is signaled via one of load sensing lines 12, 13 and said shuttle valve 8 to the compensation spool 10 so that a variable orifice formed by means of the compensation spool 10 is increased in size and a higher pressure can reach the pressure channel 4.

However, when a pressure at a working port A, B which is connected via the main spool 5 to the pressure channel 4 increases due to, for example, external forces, the pressure in the pressure channel 4 increases as well so that the compensation spool 10 is moved against the force of the spring 11 and in a first step interrupts the connection between the pressure port P and the pressure channel 4 and in a second step establishes a connection between the pressure channel 4 and the tank port T so that hydraulic fluid from the pressure channel 4 can escape to the tank port T. In any case, when the connection between the pressure port 4 and a tank port T is established, a connection between the pressure port P and the pressure channel 4 is interrupted.

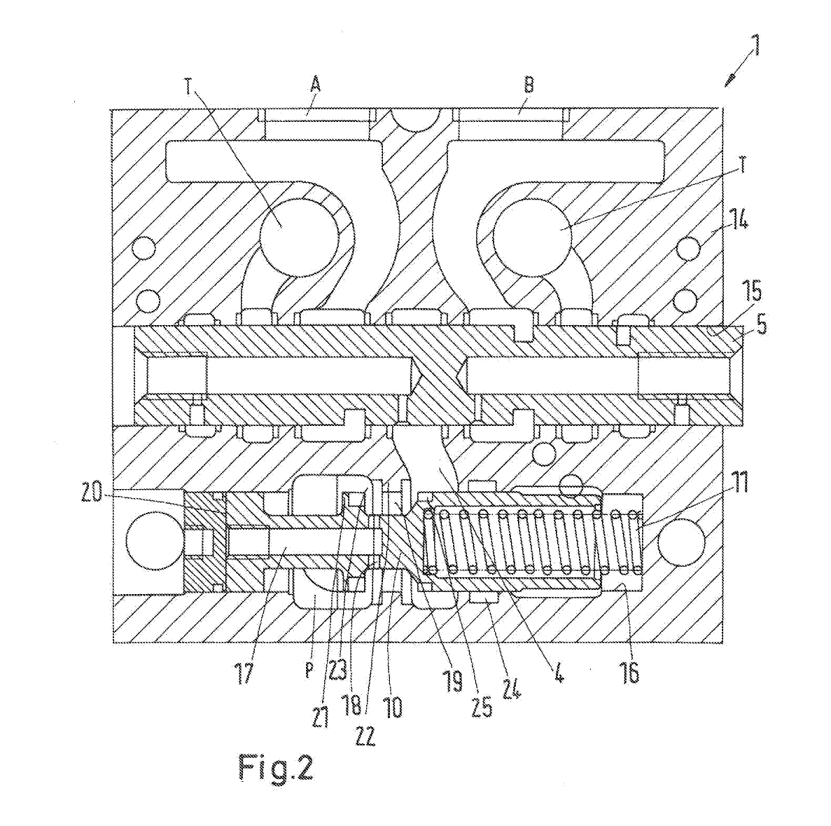

FIG. 2 shows a schematic sectional view of the valve arrangement of FIG. 1. The same elements are described using the same reference numerals.

The hydraulic valve arrangement 1 comprises a housing 14. The housing 14 has a main bore 15 in which said main spool 5 is arranged. The main spool 5 is shown schematically only.

Furthermore, the housing 14 comprises a compensation bore 16 in which the compensation spool 10 is arranged. The compensation bore 16 is connected to the pressure port P. Furthermore, the pressure channel 4 connects the main bore 15 and the compensation bore 16. The compensating spool 10 is loaded by the spring 11 in a first direction (in FIG. 2 towards the left-hand side). The compensation spool 16 comprises a longitudinal bore 17 connected via radial channels 18 to a region 19 connected to the pressure channel 4. Therefore, the pressure in the pressure channel 4 acts on a front face 20 of the compensation spool 10 in a direction opposite to the force of the spring 11.

The compensation spool 10 comprises a radial protrusion 21 cooperating with a land 22 in the housing 14, said land 22 having an internal diameter corresponding to an outer diameter of the radial protrusion 21. The protrusion 21 and the land 22 form a gap, said gap defining a variable orifice 23. The size of the orifice 23 is determined by the position of the compensation spool 10 within the compensation bore 16.

Under “normal” conditions, the compensation spool 10 is positioned so that the pressure in the pressure channel 4 corresponds to the force of the spring 11 plus the pressure in one of the load sensing lines 12, 13. When more pressure is needed, the compensation spool 10 is shifted to the left (related to the illustration in FIG. 2). When less pressure is needed, the compensation spool 10 is moved to the right.

However, in some cases the pressure at the working port connected to the pressure channel by means of the main spool 5 increases due to external conditions. In this situation the pressure in the pressure channel 4 increases as well. This pressure increase is transmitted through the pressure channel 4 and the radial channel 18 into the longitudinal bore 17 of the compensation spool 10 and shifts the compensation spool 10 to the right against the force of the spring 11 and against the highest pressure in one of the load sensing lines 12, 13.

The compensation bore 16 comprises a groove 24 connected to the tank port T (not shown in the sectional view of FIG. 2). The compensation spool 10 comprises a recess 25 in its circumferential wall. This recess 25 is open to the pressure channel 4 in radial direction and also in axial direction. This recess 25 can be continuous over the circumference of the compensation spool 10. It can, however, be interrupted in circumferential direction.

When the compensation spool 10 is shifted far enough to the right, the recess 25 comes to overlap the groove 24 so that hydraulic fluid in the pressure channel 4 can escape directly to the tank port T via the groove 24.

At the same time when the recess 25 comes to overlap the groove 24 or a short time before this instant the radial protrusion 21 is positioned within the land 22 interrupting a connection between the tank port P and the pressure channel 4 so that there is no direct flow of hydraulic fluid from the pressure port P to the tank port T.

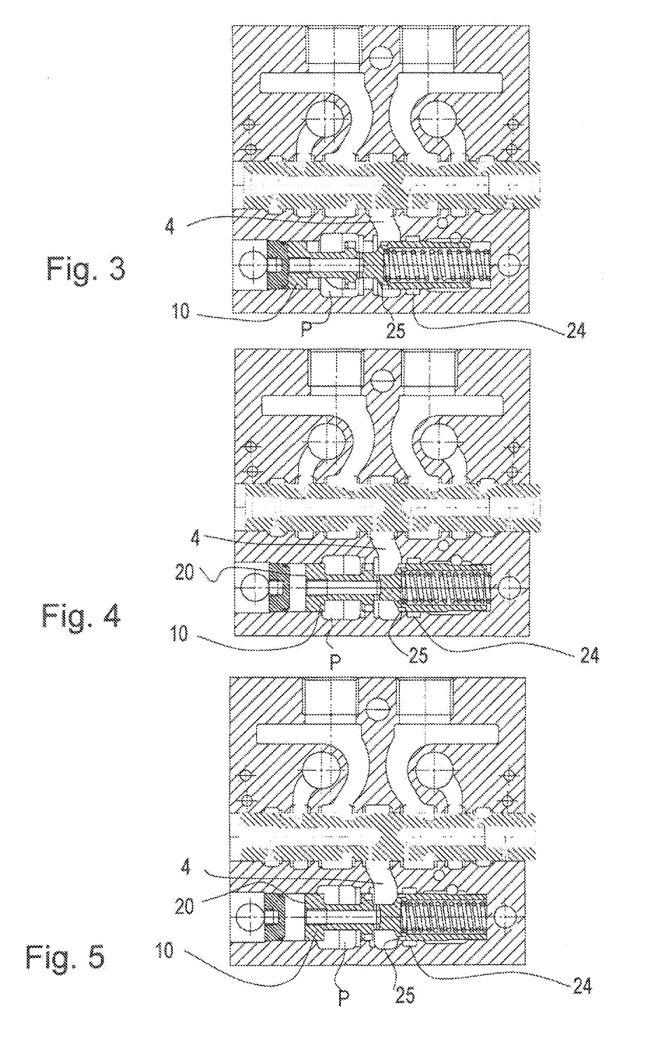

FIG. 3 shows the valve arrangement 1 with the compensation spool 10 in a first position. There is a path from the pressure port to the pressure channel. However, there is no passage from the pressure channel to the grove 24, since recess 25 does not overlap groove 24. This is almost the situation shown in FIG. 2. In this position, the compensation valve 3 operates “normally” as it is already known.

In FIG. 4 the compensation spool 10 has been shifted to the right (with respect to the illustration of FIG. 3). The space on the left hand side of front face 20 has increased. In this situation the compensation valve 3 is closed. There is no path from the pressure port P to the pressure channel 4 and no passage from the pressure channel 4 to groove 24, since recess 25 does not overlap groove 24.

In FIG. 5 the compensation spool 10 has been further shifted to the right (with respect to the illustration of FIG. 4). The space on the left hand side of front face 20 has further increased. In this situation the compensation spool 10 closes the passage from the tank port P to the tank channel 4 and opens a path from the tank channel to groove 24, since the recess 25 now overlaps channel 24.

As can be seen in FIG. 1, the compensation spool 10 is always loaded by the highest of the pressures in the load sensing lines 12, 13, i.e. by the highest of the pressures at the load sensing ports LS_{A} and LS_{B}.

The main spool 5 may be embodied as disclosed in U.S. Pat. No. 4,981,159. Not all details are shown in the drawing.

The main spool 5 comprises two annular slide grooves between which there is a central collar. To both sides outside the annular slide grooves there is a respective end collar. The collars are cylindrical but have throttle profilings at their confronting ends. The profilings are provided in pairs at diametrally opposed sides of the main spool 5. They have the form of an axial groove of which the depth and width increases towards the annular main spool groove.

To both sides of the annular pump groove 4 there is a respective annular motor groove connected to the working ports A and B. To both sides outside same, there is a respective annular tank groove and these communicate with a tank port. Still further outwardly, there are two annular sensing pressure grooves which may be connected to a pressure sensing port.

At the left hand end collar, a pressure sensing orifice is provided at each of opposite sides and it communicates with two opposed outlet apertures by way of a connecting passage in the interior of the main spool 5. Correspondingly, in the right hand end collar a pressure sensing orifice may be connected to an outlet aperture by way of a connecting passage in the main spool 5. Part of the connecting passage in the left hand end collar may be an axial bore which extends from the end of the main spool 5 and may be closable at this side, a radial bore extending to the pressure sensing orifice, and a radial bore leading to the outlet aperture. Similarly, the right hand end collar contains a connecting passage comprising an axial bore, a radial bore and a radial bore. The pressure sensing orifices are so arranged that their cross-section partially overlaps the throttle profilings axially.

In the neutral position, the throttle profilings terminate within a web between the pump channel 4 and one of the annular motor spaces so that an efficient seal is produced. Similarly, the throttle profilings terminate within a web between the pump channel 4 and the tank port or annular motor space and tank channel. The pressure sensing orifices extend into the annular container space. The webs between the annular container grooves and the annular pressure sensing grooves outside same merely have a sealing function. The outlet apertures are so placed that their cross-section partially corresponds to the annular sensing pressure groove and is partially covered by the end section of the housing bore 15. Consequently, tank pressure obtains at the pressure sensing connections.

In particular, the throttle profilings may be formed by axial grooves which increase in cross-section towards the annular main spool groove. Above all, the axial grooves may increase in depth and width towards the annular main spool groove. In this way, the desired throttle cross-section is obtained with a very short circumferential extent.

Every two identical throttle profilings may be diametrally opposed at the circumference of the main spool 5. This results in hydraulic equilibrium during operation.

It is favourable for the at least one pressure sensing orifice to be disposed at the height of the flat end of the throttle profiling. The cross-section of the pressure sensing orifice may even partially axially overlap the throttle profiling. This results in short or extremely short dead play.

The connecting passage may lead to an outlet aperture which is disposed at the circumference of the end collars and which, at least in the operative position of the main spool 5, communicates with one of two annular pressure sensing grooves disposed in the housing bore axially beyond the annular container grooves. This permits a simple connection to a pressure sensing connection fixed with respect to the housing and closure of the connecting passage if this is necessary.

The connecting passage may have an axial bore which extends from the end of the main spool 5 and is connected by a respective radial bore to a pressure sensing orifice and an outlet aperture. Such a construction is easy to bring about.

The two ends of a diametral bore may form two pressure sensing orifices. The diametral bore is easy to produce. In addition, hydraulic equilibrium is obtained.

The pressure sensing orifice may be disposed in one end collar to determine the load pressure in an annular motor groove. By displacement towards the annular pump groove, the pressure sensing orifice comes into communication with the annular motor groove whilst the latter is at the same time connected to the annular pump groove by way of a throttle profiling.

In addition, it is possible for the pressure sensing orifice to be in communication with an annular container groove in the neutral position. The container pressure may therefore obtain in the pressure sensing system in the neutral position.

In an alternative construction, the pressure sensing orifice is disposed in the central collar to determine the inlet pressure in the annular pump groove. In the neutral position, it is covered by bore sections but on commencement of the operative position it comes into communication with the annular pump groove together with the adjacent throttle profiling.

It is possible that a fixed throttle be provided in the connecting passage and a variable throttle depending on the main spool 5 position at the outside of the main spool 5 between the annular sensing pressure groove and the annular container groove. In this way one obtains a series circuit of two throttles between the annular pump groove and the annular container groove. The pressure obtaining in the annular pressure sensing groove depends on the ratio of the throttle resistances and thus on the main spool 5 position.

Existing bores may be used as the fixed throttle if their cross-section is appropriately dimensioned. The variable throttle preferably comprises an axially extending throttle groove which is circumferentially offset from the outlet aperture and has a cross-section decreasing towards the end of the main spool 5. This throttle cross-section can be very accurately selected so that the characteristic pressure curve accurately reproduces the main spool 5 position.

Advantageously, in the neutral position at the axially outer end of the annular sensing pressure groove the outlet aperture is in communication therewith. This outlet aperture moves towards the free end of the housing bore only when it is at the load pressure of the delivery side. Sealing problems can therefore not arise. It is possible for the outlet aperture to be in communication with the annular sensing pressure groove in the neutral position.

The pressure compensated control, as described above, maintains constant system pressure in the hydraulic circuit by varying the output flow of the pump. Used with a closed center control valve, the pump remains in high pressure standby mode at the pressure compensated setting with zero flow until the function is actuated. Once the closed center valve is opened, the pressure compensated control senses the immediate drop in system pressure and increases pump flow by increasing the swashplate angle. The pump continues to increase flow until system pressure reaches the pressure compensated setting. If system pressure exceeds the pressure compensated setting, the pressure compensated control reduces the swashplate angle to maintain system pressure by reducing flow. The pressure compensated control continues to monitor system pressure and changes swashplate angle to match the output flow with the work function pressure requirements. If the demand for flow exceeds the capacity of the pump, the pressure compensated control directs the pump to maximum displacement. In this condition, actual system pressure depends on the actuator load.

The pressure compensated system characteristics are among others constant pressure and variable flow, high pressure standby mode when flow is not needed, system flow adjusts to need system requirements, single pump can provide flow to multiple work functions, and quick response to system flow and pressure requirements.

Typical applications for pressure compensated systems are constant force cylinders (bailers, compactors, refuse trucks), on/off fan drives, drill rigs, sweepers, and trenchers.

While the present invention has been illustrated and described with respect to a particular embodiment thereof, it should be appreciated by those of ordinary skill in the art that various modifications to this invention may be made without departing from the spirit and scope of the present.

What is claimed is:

1. A hydraulic valve arrangement comprising a supply port arrangement having a pressure port (P) and a tank port (T), a working port arrangement having at least a working port (A, B), a main valve, and a compensation valve, said compensation valve being arranged between said pressure port (P) and a pressure channel connected to said main valve, said compensation valve forming a variable orifice between said pressure port (P) and said pressure channel, wherein said compensation valve is adjustable to connect said pressure channel to said tank port (T).

2. The hydraulic valve arrangement according to claim 1, wherein said compensation valve is adjustable to interrupt a connection between said pressure port (P) and said pressure channel.

3. The hydraulic valve arrangement according to claim 2, wherein said compensation valve interrupts said connection between said pressure port (P) and said pressure channel when connecting said pressure channel to said tank port (T).

4. The hydraulic valve arrangement according to claim 1, wherein said compensation valve is actuated by a pressure in said pressure channel.

5. The hydraulic valve arrangement according to claim 1, comprising a housing, said housing having a main bore and a compensation bore, said main bore and said compensation bore being connected by said pressure channel, said main spool slidably arranged within said main bore and forming part of said main valve, said compensation spool slidably arranged within said compensation bore and forming part of said compensation valve, said compensation bore comprising a pressure relief outlet connected to said tank port (T) and said compensation spool being movable into a pressure relief position in which said pressure relief outlet is connected to said pressure channel.

6. The hydraulic valve arrangement according to claim 5 wherein said compensation spool is movable in a first direction and in a second direction opposite said first direction, wherein said compensation spool in said first direction is loaded by said pressure in said pressure channel and in said second direction is loaded by a resetting force.

7. The hydraulic valve arrangement according to claim 6, wherein said resetting force is at least partly formed by a pressure in a load sensing port (LS_{A}, LS_{B}) of said valve arrangement.

8. The hydraulic valve arrangement according to claim 7, wherein a plurality of load sensing ports (LS_{A}, LS_{B}) is provided and said resetting force is at least partly formed by the highest of the pressures at said plurality of load sensing ports (LS_{A}, LS_{B}).

9. The hydraulic valve arrangement according to claim 5, wherein said pressure relief outlet comprises a groove in a circumferential wall of said compensation bore.

10. The hydraulic valve arrangement according to claim 9, wherein said compensation spool comprises a recess in its circumference, said recess in said pressure relief position connecting said groove to said pressure channel.

11. The hydraulic valve arrangement according to claim 2, wherein said compensation valve is actuated by a pressure in said pressure channel.

12. The hydraulic valve arrangement according to claim 3, wherein said compensation valve is actuated by a pressure in said pressure channel.

13. The hydraulic valve arrangement according to claim 2, comprising a housing, said housing having a main bore and a compensation bore, said main bore and said compensation bore being connected by said pressure channel, said main spool slidably arranged within said main bore and forming part of said main valve, said compensation spool slidably arranged within said compensation bore and forming part of said compensation valve, said compensation bore comprising a pressure relief outlet connected to said tank port (T) and said compensation spool being movable into a pressure relief position in which said pressure relief outlet is connected to said pressure channel.

14. The hydraulic valve arrangement according to claim 3, comprising a housing, said housing having a main bore and a compensation bore, said main bore and said compensation bore being connected by said pressure channel, said main spool slidably arranged within said main bore and forming part of said main valve, said compensation spool slidably arranged within said compensation bore and forming part of said compensation valve, said compensation bore comprising a pressure relief outlet connected to said tank port (T) and said compensation spool being movable into a pressure relief position in which said pressure relief outlet is connected to said pressure channel.

15. The hydraulic valve arrangement according to claim 4, comprising a housing, said housing having a main bore and a compensation bore, said main bore and said compensation bore being connected by said pressure channel, said main spool slidably arranged within said main bore and forming part of said main valve, said compensation spool slidably arranged within said compensation bore and forming part of said compensation valve, said compensation bore comprising a pressure relief outlet connected to said tank port (T) and said compensation spool being movable into a pressure relief position in which said pressure relief outlet is connected to said pressure channel

16. The hydraulic valve arrangement according to claim 6, wherein said pressure relief outlet comprises a groove in a circumferential wall of said compensation bore.

17. The hydraulic valve arrangement according to claim 7, wherein said pressure relief outlet comprises a groove in a circumferential wall of said compensation bore.

18. The hydraulic valve arrangement according to claim 8, wherein said pressure relief outlet comprises a groove in a circumferential wall of said compensation bore.
